(19) United States
(12) Patent Application Publication
(10) Pub. No.: US 2017/0093493 A1
(43) Pub. Date: Mar. 30, 2017

(54) CORRECTION OF CHROMATIC DISPERSION IN REMOTE DISTRIBUTED SENSING

(71) Applicant: Halliburton Energy Services, Inc., Houston, TX (US)

(72) Inventors: Jason Edward Therrien, Cypress, TX (US); John L. Maida, Houston, TX (US); David Barfoot, Houston, TX (US)

(21) Appl. No.: 15/039,132

(22) PCT Filed: Dec. 30, 2014
(86) PCT No.: PCT/US14/72765

§ 371 Date: May 25, 2016

(51) Int. Cl. H04B 10/2519; H04B 10/2543; H04B 10/079

(52) U.S. Cl. CPC H04B 10/2519; H04B 10/07951; H04B 10/2543

(57) ABSTRACT

Systems and methods for correcting chromatic dispersion in a remote distributed sensing application are disclosed. A remote distributed sensing system includes an interrogation subsystem configured to transmit an optical pulse and receive a reflection from the optical pulse. The remote distributed sensing system also includes a transit optical fiber coupled to the interrogation subsystem and having chromatic dispersion of a first slope at a frequency of the optical pulse, and an optical fiber under test being located in a remote location apart from the interrogation subsystem. The remote distributed sensing system additionally includes a chromatic dispersion compensator coupled in-line with at least one of the transit optical fiber and the optical fiber under test to adjust chromatic dispersion on the optical pulse in a direction of a second slope having an opposite sign from the first slope.

### TECHNICAL FIELD

The present disclosure relates generally to distributed sensing using optical fibers and, more particularly, to correction of chromatic dispersion in remote distributed sensing applications.

### BACKGROUND

Natural resources, such as hydrocarbons and water, are commonly obtained from subterranean formations that may be located onshore or offshore. The development of subterranean operations and the processes involved in removing natural resources typically involve a number of different steps such as, for example, drilling a borehole at a desired well site, treating the borehole to optimize production of the natural resources, and performing the necessary steps to produce and process the natural resources from the subterranean formation.

When performing subterranean operations, it may be desirable to obtain information about the subterranean formation. One method of obtaining information about the formation is the use of distributed sensing. In a distributed sensing system, an optical pulse may be conveyed by an optical fiber in the subterranean formation. As the optical pulse travels through the fiber, various points along the fiber may reflect energy from the optical pulse, for example, in the form of Rayleigh backscatter. By receiving and processing the reflections properly, information about the formation may be resolved including acoustic pressure, particle vibration, particle displacement, particle velocity, particle acceleration, temperature, strain, pressure, and distributions thereof along the formation.

### BRIEF DESCRIPTION OF THE DRAWINGS

For a more complete understanding of the present disclosure and its features and advantages, reference is now made to the following description, taken in conjunction with the accompanying drawings, in which:

FIG. 1 illustrates an exemplary remote distributed sensing system associated with a well system;

FIG. 2 illustrates a block diagram of an exemplary interrogation subsystem used in a remote distributed sensing system;

FIG. 3 illustrates a graph of an exemplary optical pulse transmitted by an interrogation subsystem;

FIGS. 4A, 4B, and 4C illustrate graphs of an exemplary optical pulse transmitted by an interrogation subsystem as chromatic dispersion is introduced onto the optical pulse;

FIGS. 4D and 4E illustrate graphs of an exemplary optical pulse affected by chromatic dispersion after the chromatic dispersion is corrected by exemplary chromatic dispersion compensators; and

FIG. 5 illustrates a Rayleigh backscatter plot of exemplary reflections received by an interrogation subsystem.

### DETAILED DESCRIPTION

The present disclosure describes systems and methods for correction of chromatic dispersion in remote distributed sensing applications. During subterranean operations, remote distributed sensing may be utilized to measure physical parameters of a remote location that is difficult to monitor using traditional monitoring techniques. For example, remote distributed sensing applications may include an optical fiber under test located downhole in a subterranean formation several kilometers from an interrogation subsystem located at the surface. As such, a remote distributed sensing system may employ a transit optical fiber to convey an optical pulse from the interrogation subsystem to the optical fiber under test positioned in the remote location of interest. The transit fiber may also convey reflections of the optical pulse from the fiber under test back to the interrogation subsystem.

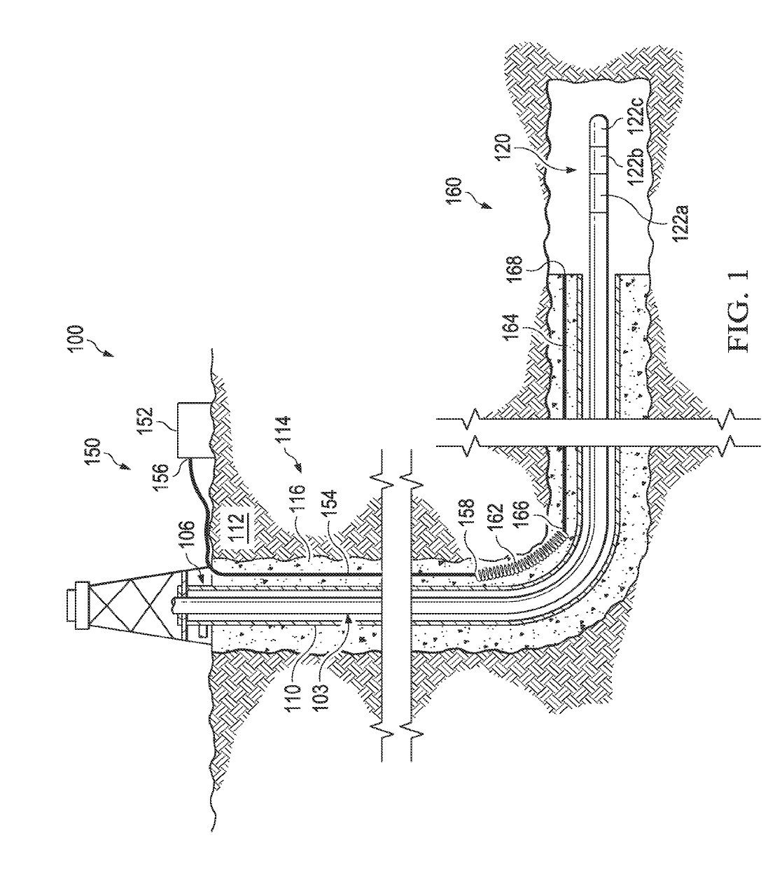

As described in more detail below, a chromatic dispersion compensator coupled in-line with the transit fiber or the fiber under test may be used to correct, manage, and/or decrease chromatic dispersion on the optical pulse as it travels toward a downhole end of the fiber under test, thus improving the signal-to-noise ratio of the remote distributed sensing system or otherwise facilitating distributed sensing at long distances. While the present disclosure is directed to remote distributed sensing applications in subterranean wellbores, the systems and methods disclosed for correcting chromatic dispersion may be adapted for use in other distributed sensing applications such as telephone lines, power lines, pipelines, transportation lines, and other applications comprising long transit optical fibers and/or long optical fibers under test. Embodiments of the present disclosure and its advantages may be understood by referring to FIGS. 1 through 5, where like numbers are used to indicate like and corresponding parts.

FIG. 1 illustrates an exemplary remote distributed sensing system associated with a well system. As shown, well system 100 may include well surface or well site 106. Various types of equipment such as a rotary table, drilling fluid or production fluid pumps, drilling fluid tanks (not expressly shown), and other drilling or production equipment may be located at well surface or well site 106. For example, well site 106 may include drilling rig 102 that may have various characteristics and features associated with a “land drilling rig.” However, downhole drilling tools incorporating teachings of the present disclosure may be satisfactorily used with drilling equipment located on offshore platforms, drill ships, semi-submersibles and drilling barges (not expressly shown).

Well system 100 may also include production string 103, which may be used to produce hydrocarbons such as oil and gas and other natural resources such as water from formation 112 via wellbore 114. As shown in FIG. 1, wellbore 114 has a substantially vertical portion (e.g., substantially perpendicular to the surface) and a substantially horizontal portion (e.g., substantially parallel to the surface). In other examples, wellbore 114 may be substantially vertical or substantially horizontal, or may have portions formed at an angle between vertical and horizontal. Casing string 110 may be placed in wellbore 114 and held in place by cement 116, which may be injected between casing string 110 and the sidewalls of wellbore 114. Casing string 110 may provide radial support to wellbore 114 and may seal against unwanted communication of fluids between wellbore 114 and surrounding formation 112. Casing string 110 may extend from well surface 106 to a selected downhole location within wellbore 114. Portions of wellbore 114 that do not include casing string 110 may be described as “open hole.”

The terms “uphole” and “downhole” may be used to describe the location of various components relative to the bottom or end of wellbore 114 shown in FIG. 1. For example, a first component described as uphole from a second component may be further away from the end of wellbore 114 than the second component. Similarly, a first component described as being downhole from a second component may be located closer to the end of wellbore 114 than the second component.

Well system 100 may also include downhole assembly 120 coupled to production string 103. Downhole assembly 120 may be used to perform operations relating to the completion of wellbore 114, the production of hydrocarbons from formation 112 via wellbore 114, and/or the maintenance of wellbore 114. Downhole assembly 120 may be located at the end of wellbore 114 or at a point uphole from the end of wellbore 114. Downhole assembly 120 may be formed from a wide variety of components configured to perform these operations. For example, components 122a, 122b and 122c of downhole assembly 120 may include screens, flow control devices, and/or other components to facilitate production or well maintenance. The number and types of components 122 included in downhole assembly 120 may depend on the type of wellbore, the operations being performed in the wellbore, and anticipated wellbore conditions.

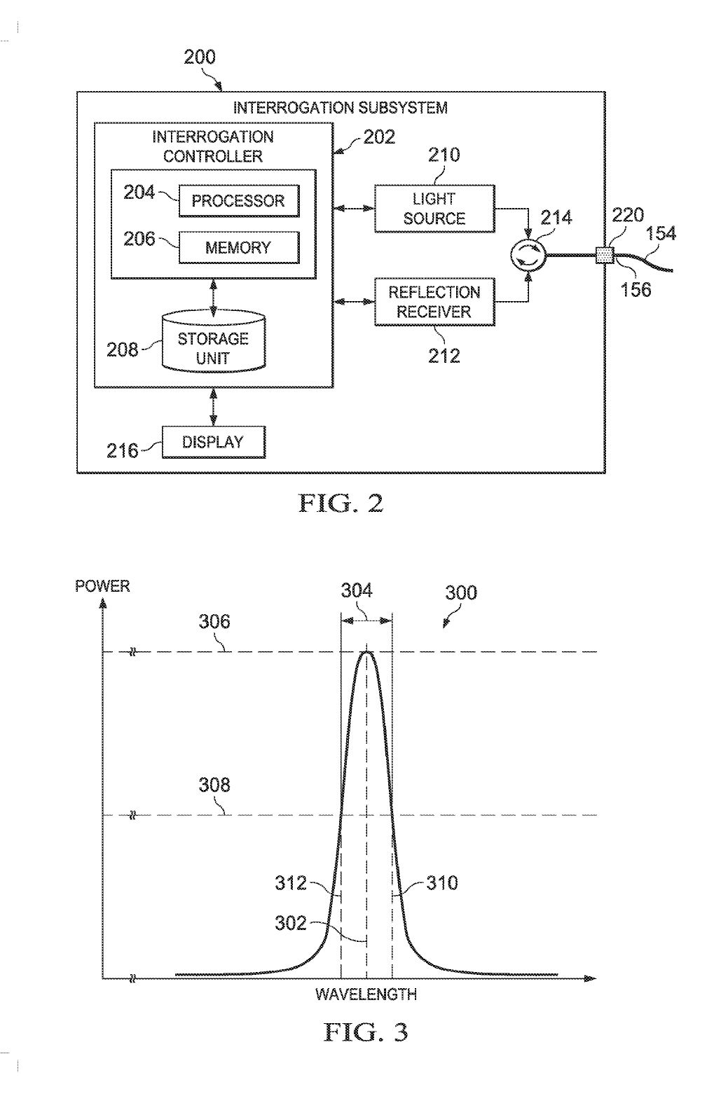

FIG. 1 further illustrates an exemplary remote distributed sensing system associated with well system 100. Remote distributed sensing system 150 may use remote distributed sensing to measure physical parameters at remote location 160 within wellbore 114. Remote location 160 may be many kilometers downhole from well surface 106 within wellbore 114. As shown, remote distributed sensing system 150 may include interrogation subsystem 152 at the surface, transit optical fiber 154, optical fiber under test 164, and chromatic dispersion compensator 162. In FIG. 1, uphole end 156 of transit fiber 154 is coupled to interrogation subsystem 152, downhole end 158 of transit fiber 154 is coupled to uphole end 166 of fiber under test 164, and downhole or reflection end 168 of fiber under test 164 represents a downhole-most point of remote distributed sensing system 150. Additionally, as shown, chromatic dispersion compensator 162 may be coupled in-line with transit fiber 154 and fiber under test 164 between downhole end 158 of transit fiber 154 and uphole end 166 of fiber under test 164. Well system 100 and remote distributed sensing system 150 are not drawn to scale and may include additional or fewer components than illustrated by FIG. 2 and the components illustrated in FIG. 2 may be rearranged in various embodiments.

In certain embodiments, remote distributed sensing system 150 may be integrated with a well system that is not yet completed and that may include components such as drill strings, drill bits, coring bits, drill collars, rotary steering tools, directional drilling tools, downhole drilling motors, reamers, hole enlargers, and/or stabilizers (not shown).

Remote distributed sensing system 150 may be used to monitor drilling, exploration, and/or extraction operations at remote location 160. Remote distributed sensing system 150 may be installed by any means, for any length of time, and for any purpose as suits a particular embodiment. For example, as shown in FIG. 1, remote distributed sensing system 150 may be encased in cement 116 as a “cradle to grave” monitoring solution for permanent and fully developed portions of a wellbore. In other examples, remote distributed sensing system 150 may be integrated with other elements of well system 100 and/or may be installed by various suitable methodologies. In certain examples, remote distributed sensing system 150 may employ a temporary monitoring solution and/or may be utilized to monitor an “open hole” portion of wellbore 114.

Remote distributed sensing system 150 may facilitate distributed measurements, or measurements of parameters all along remote location 160 rather than merely at a single point. For example, remote distributed sensing system 150 may measure physical parameters by using time-domain reflectometry or frequency-domain reflectometry. Specifically, interrogation subsystem 152 may transmit an optical pulse into transit fiber 154, which may convey the optical pulse to fiber under test 164, which may be positioned along the length of remote location 160. Because localized differences in physical parameters (e.g., acoustic pressure, particle vibration, temperature, etc.) may affect various portions of fiber under test 164, characteristics of light transmission may vary along fiber under test 164. Thus, as the optical pulse travels through fiber under test 164, Rayleigh scattering and/or other optical phenomena may cause small portions of the energy of the optical pulse to be reflected back toward interrogation subsystem 152, even as the optical pulse continues forward away from interrogation subsystem 152. Reflections (e.g., Rayleigh backscatter) from the optical pulse may contain information about the localized differences in physical parameters at the various points along fiber under test 164 from which the reflections originated. Accordingly, by accounting for the phase velocity of the optical pulse in transit fiber 154 and fiber under test 164, interrogation subsystem 152 may receive the reflections, derive information about the physical parameters from the reflections, and spatially resolve the information to physical positions along remote location 160 according to the arrival time of the reflections. Interrogation subsystem 152 may thereby create a continuous and comprehensive picture of the physical parameters along fiber under test 164. While energy may also be reflected back from transit fiber 154 to interrogation subsystem 152 carrying information about physical parameters along transit fiber 154, these reflections may be ignored by interrogation subsystem 152 because the portion of wellbore 114 along transit fiber 154 may not be of interest.

An optical effect known as chromatic dispersion may be detrimental to remote distributed sensing systems. For example, chromatic dispersion may impose significant limits on remote distributed sensing systems such as an upper bound on the total length of optical fiber from which an interrogation subsystem can successfully obtain information. Chromatic dispersion may increase on an optical pulse as the optical pulse travels through an optical fiber. Specifically, chromatic dispersion may cause energy from a central frequency of the optical pulse to disperse into sideband frequencies of the optical pulse. As the energy disperses, reflections analyzed at the central frequency may get weaker while noise from reflections at the sideband frequencies may get simultaneously stronger. As a result, a signal-to-noise ratio of the reflections received at the interrogation subsystem may significantly diminish, and may become insufficient for the interrogation subsystem to properly resolve information.

Chromatic dispersion may be introduced onto an optical pulse in various ways. For example, “classical” chromatic dispersion may refer to chromatic dispersion introduced onto an optical pulse with a nonzero optical pulse width due to inherent properties of a fiber or other medium the optical pulse travels through. In contrast, “Kerr effect” chromatic dispersion may occur on an optical pulse with a power level sufficient to induce nonlinear effects in the fiber or other medium the optical pulse travels through. Chromatic dispersion may be introduced onto an optical pulse by the classical effect, by the Kerr effect, by other optical phenomena, or by any combination thereof.

Classical chromatic dispersion arises due to optical properties of media through which light travels. For example, light traveling through an optical fiber may be subject to chromatic dispersion that would not be present if the light were traveling through a vacuum. While a vacuum may convey light of all frequencies at an equal phase velocity, optical fibers may convey light with different frequencies and wavelengths at different phase velocities. For example, light with a wavelength of approximately 1540 nanometers (nm) may travel through a certain optical fiber slightly faster than light with a wavelength of approximately 1560 nm and the optical fiber may be said to have positive chromatic dispersion at such wavelengths or at frequencies corresponding to such wavelengths. An optical fiber that has positive chromatic dispersion at a certain wavelength may be referred to as “positive dispersion fiber” at that wavelength. However, the same optical fiber may also have a region of negative chromatic dispersion. For example, for wavelengths smaller than 1300 nm, the fiber may convey light with longer wavelengths slightly faster than light with shorter wavelengths. Accordingly, the same fiber may be referred to as “negative dispersion fiber” at wavelengths shorter than 1300 nm. In this example, 1300 nm may be referred to as a “zero dispersion point” of the fiber since it is the wavelength at which chromatic dispersion inverts from positive to negative. Various optical fibers may exhibit various classical chromatic dispersion characteristics and may have various zero dispersion points. For example, certain optical fibers may have negative chromatic dispersion for wavelengths longer than the zero dispersion point and/or may have multiple zero dispersion points.

Kerr effect chromatic dispersion refers to chromatic dispersion originating from a phenomenon known as the optical Kerr effect. The Kerr effect may arise when an optical pulse is transmitted through an optical fiber at a sufficiently large power level to induce nonlinearity in the fiber. Specifically, the energy in the optical pulse may be such that an electric field generated by the optical pulse alters the permittivity of the fiber itself, according to quantum electrodynamic theory. In effect, photons within the optical pulse may become so energized that they react with themselves to create new photons at new wavelengths. Thus, even if a monochromatic or near-monochromatic optical pulse is generated to be immune to classical chromatic dispersion, new sidebands apart from the central frequency of the monochromatic optical pulse may still arise due to the Kerr effect if the optical pulse has a sufficiently large power level. Sidebands induced by the Kerr effect may also grow over distance in the fiber. Accordingly, though the underlying cause of Kerr effect chromatic dispersion is different from classical chromatic dispersion, the end result may be the same: the signal-to-noise ratio at a receiver may be diminished, the receiver may eventually fail all together to derive useful information from the signal, and an inherent limitation on the distance a fiber under test is located away from an interrogation subsystem may be imposed.

As shown in FIG. 1, remote distributed sensing system 150 may include interrogation subsystem 152, which may be located on well surface 106. Interrogation subsystem 152 may be self-contained at well surface 106, located at an offsite location such as a computer data center or well operations facility, and/or distributed with certain components at well surface 106 and other components offsite. For example, interrogation subsystem 152 may perform certain functions (e.g., transmitting optical pulses, receiving reflections, etc.) at well surface 106 and other functions (e.g., directing optical pulses to be transmitted, processing received reflections to resolve information about the remote location, etc.) offsite.

Interrogation subsystem 152 may be configured to generate an optical pulse to be conveyed downhole to fiber under test 164 by transit fiber 154. For example, interrogation subsystem 152 may include a coherent laser source that may generate and transmit an optical pulse having a power level sufficient to induce a nonlinear effect (e.g. a Kerr effect) in the optical fiber. Interrogation subsystem 152 may be further configured to receive a reflection from the optical pulse. For example, the reflection from the optical pulse may include Rayleigh backscatter. Interrogation subsystem 152 may be further configured to analyze the reflection to obtain information about remote location 160. For example, interrogation subsystem 152 may be configured to analyze the reflection using time-domain and/or frequency-domain reflectometry to detect distributed information including acoustic pressure, particle vibration, particle displacement, particle velocity, particle acceleration, temperature, strain, pressure, and/or any combination thereof. After analyzing all reflections received from the optical pulse, interrogation subsystem 152 may transmit additional optical pulses, timed such that continuous reflections may be received but reflections from consecutive optical pulses do not overlap.

Transit fiber 154 may have chromatic dispersion of a particular slope at the frequency of the optical pulse transmitted by interrogation subsystem 152. For example, transit fiber 154 may have strong positive chromatic dispersion (e.g., with a relatively steep positive slope), weak positive chromatic dispersion (e.g., with a less steep positive slope), strong negative chromatic dispersion (e.g., with a relatively steep negative slope), weak negative chromatic dispersion (e.g., with a less steep negative slope), or no chromatic dispersion (e.g., with a relatively flat slope). Because transit fiber 154 may convey an optical pulse from interrogation subsystem 152 to fiber under test 164, transit fiber 154 may be relatively long, for example several kilometers long. As transit fiber 154 conveys the optical pulse from interrogation subsystem 152 toward fiber under test 164, classical and/or Kerr effect chromatic dispersion may increase on the optical pulse according to the slope of the chromatic dispersion and to the sign (e.g., positive or negative) of the slope.

Fiber under test 164 may be positioned along remote location 160, which may be several kilometers from interrogation subsystem 152. Like transit fiber 154, fiber under test 164 may also convey optical pulses and reflections from the optical pulses. Fiber under test 164 may be further configured to originate reflections by reflect energy from the optical pulse (e.g., in the form of Rayleigh backscatter) at one or more points along fiber under test 164. For example, fiber under test 164 may be a high backscatter optical fiber adapted to facilitate generation of useful reflections as optical pulses pass through fiber under test 164. Fiber under test 164 may be constructed from any type of optical fiber available. For example, fiber under test 164 may have chromatic dispersion of an arbitrary slope that is unrelated to the slope of transit fiber 154. Fiber under test 164 may also have a reflection end 168 at a downhole-most point of remote location 160 where a remaining portion of energy of the optical pulse not reflected by transit fiber 154 or fiber under test 164 may be reflected to return back to interrogation subsystem 152.

In certain examples, transit fiber 154 and fiber under test 164 may have unique characteristics (e.g., chromatic dispersion slope) not shared by the other and may be distinct optical fibers coupled together. In other examples, one unitary optical fiber may include various portions including a portion referred to as transit fiber 154 and another portion referred to as fiber under test 164. As such, the distinction between transit fiber 154 and fiber under test 164 may be based not on the distinctness of two separate fibers, but rather on a positioning of the portions of the unitary fiber. Specifically, fiber under test 164 may simply be defined as the portion of the unitary fiber positioned along an area of interest (e.g., remote location 160).

Chromatic dispersion compensator 162 may be coupled in-line with at least one of transit fiber 154 and fiber under test 164 to adjust chromatic dispersion on an optical pulse in a direction of a particular slope having an opposite sign from the slope of transit fiber 154 (e.g., negative chromatic dispersion) as the optical pulse travels from interrogation subsystem 152 toward reflection end 168 of fiber under test 164. In particular, chromatic dispersion compensator 162 may be configured to adjust Kerr effect chromatic dispersion on an optical pulse transmitted by a coherent laser source at a power level sufficient to induce a nonlinear effect in transit fiber 154 and/or in fiber under test 164, where the Kerr effect chromatic dispersion is associated with (e.g., a result of) the power level of the optical pulse.

In some examples, chromatic dispersion compensator 162 may be coupled in-line between downhole end 158 of transit fiber 154 and uphole end 166 of fiber under test 164, as shown in FIG. 1. Placement of chromatic dispersion compensator 162 immediately before fiber under test 164 may be advantageous because chromatic dispersion may be corrected after increasing on an optical pulse over a long distance of transit fiber 154 but immediately before the optical pulse enters fiber under test 164. Accordingly, chromatic dispersion compensator 162 may correct all or a portion of chromatic dispersion introduced onto the optical pulse while traveling through transit fiber 154, effectively coupling fiber under test 164 to interrogation subsystem 152 directly.

In other examples not shown, chromatic dispersion compensator 162 may be coupled in-line elsewhere along transit fiber 154 or fiber under test 164. For example, chromatic dispersion compensator 162 may be coupled in-line along transit fiber 154 prior to downhole end 158 or along fiber under test 164 prior to downhole end 168. In addition, certain embodiments of remote distributed sensing system 150 may include two or more chromatic dispersion compensators coupled in-line with at least one of transit fiber 154 and fiber under test 164. For example, remote distributed sensing system 150 may include a first chromatic dispersion compensator coupled in-line along transit fiber 154 midway between uphole end 156 and downhole end 158, and a second chromatic dispersion compensator coupled in-line between downhole end 158 of transit fiber 154 and uphole end 166 of fiber under test 164.

Chromatic dispersion compensator 162 may adjust chromatic dispersion in any suitable way. For example, chromatic dispersion compensator 162 may be “lumped” so that a chromatic dispersion adjustment may be performed over a relatively short distance in wellbore 114, or chromatic dispersion compensator 162 may be “distributed” so that chromatic dispersion compensation may be performed over a longer distance during transit towards or along fiber under test 164. As one example, chromatic dispersion compensator 162 may be composed of an optical fiber having chromatic dispersion of a slope opposite in sign from the slope of transit fiber 154 at the frequency of the optical pulse. For example, chromatic dispersion compensator 162 may be constructed from an optical fiber that mirrors the chromatic dispersion and the length of transit fiber 154. Thus, if transit fiber 154 is 2 km long with chromatic dispersion of +50 ps/(km*nm) at the frequency of the optical pulse, chromatic dispersion compensator 162 may be composed of an optical fiber that is 2 km long and has chromatic dispersion of −50 ps/(km*nm) at the frequency of the optical pulse. In some embodiments, the 2 km long dispersion compensator 148 may be lumped (e.g., wrapped up or coiled) within a small volume.

As another example, chromatic dispersion compensator 162 may be an optical fiber of a shorter length and a stronger chromatic dispersion than transit fiber 154. Thus, if transit fiber 154 is 2 km long with chromatic dispersion of +50 ps/(km*nm), chromatic dispersion compensator 162 may be an optical fiber that is 10 m long with chromatic dispersion of −10 ns/(km*nm). In other embodiments, chromatic dispersion compensator 162 may include a fiber Bragg grating configured to introduce chromatic dispersion in a direction of the particular slope opposite in sign from the slope of transit fiber 154 onto the optical pulse. Thus, if transit fiber 154 has positive chromatic dispersion at the frequency of the optical pulse, chromatic dispersion compensator 162 may be a negative dispersion fiber and/or a fiber Bragg grating configured to introduce negative dispersion onto the optical pulse. Conversely, if transit fiber 154 has negative chromatic dispersion at the frequency of the optical pulse, chromatic dispersion compensator 162 may be a positive dispersion fiber and/or a fiber Bragg grating configured to introduce positive chromatic dispersion onto the optical pulse.

Chromatic dispersion compensator 162 may be installed into remote distributed sensing system 150 in any suitable way and at any suitable point in the lifetime of well system 100 and/or remote distributed sensing system 150. For example, chromatic dispersion compensator 162 may be installed at the same time fiber under test 164 and/or transit fiber 154 are installed. Transit fiber 154 and fiber under test 164 may be coupled to chromatic dispersion compensator 162 at the surface and then installed together as part of a new remote distributed sensing system. In other examples, chromatic dispersion compensator 162 may be coupled in-line with transit fiber 154 and/or to fiber under test 164 as a retrofit after transit fiber 154 has been coupled to interrogation subsystem 152 and to fiber under test 164, and after fiber under test 164 has been positioned in remote location 160. For example, a previously installed remote distributed sensing system that has been in operation for a period of time may be retrofitted with a chromatic dispersion compensator to improve the signal-to-noise ratio of the system and/or to allow a transit fiber and/or a fiber under test to be lengthened. Specifically, if a transit fiber stretches from an interrogation subsystem at the ocean surface to a fiber under test extending subterraneously under the ocean floor in a certain embodiment, a chromatic dispersion compensator consisting of a spool of optical fiber with opposite slope chromatic dispersion from the transit fiber may be installed in a mud surface chamber (e.g., a high pressure or a low pressure chamber) at the ocean floor.

FIG. 2 illustrates a block diagram of an exemplary interrogation subsystem 200 used in a remote distributed sensing system. In FIG. 2, interrogation subsystem 200 may represent an embodiment of interrogation subsystem 152 described above with respect to FIG. 1. As shown, interrogation subsystem 200 may include interrogation controller 202, light source 210, reflection receiver 212, power circulator 214, display 216, and bulkhead connector 220. The elements shown in FIG. 2 are exemplary only and interrogation subsystem 200 may include fewer or additional elements in other embodiments.

In operation, interrogation subsystem 200 may be configured such that interrogation controller 202 directs light source 210 to generate an optical pulse, light source 210 transmits the optical pulse into transit fiber 154 via power circulator 214, reflection receiver 212 receives a reflection from the optical pulse also via power circulator 214, and interrogation controller 202 analyzes the reflection received using time-domain reflectometry, frequency-domain reflectometry, or another methodology to detect information from the optical pulse. Although not shown in FIG. 2, transit fiber 154 may also be coupled to fiber under test 164 and/or chromatic dispersion compensator 162 as illustrated and discussed in relation to FIG. 1. Accordingly, the reflection received by reflection receiver 212 may originate from a point along any of transit fiber 154, chromatic dispersion compensator 162, and fiber under test 164, and may contain information about a physical parameter at the point from which the reflection originated.

As shown, interrogation controller 202 may be communicatively coupled to light source 210 and reflection receiver 212. In some embodiments, interrogation controller 202 may also be communicatively coupled to one or more displays 216 such that information such as the physical parameters of points along fiber under test 164 may be conveyed to onsite and/or offsite operators of drilling and logging equipment. Interrogation controller 202 may include various components suited to a particular embodiment. For example, as shown in FIG. 2, interrogation controller 202 may include processor 204, memory 206, and storage unit 208 communicatively coupled one to another.

Processor 204 may include a microprocessor, microcontroller, digital signal processor (DSP), application specific integrated circuit (ASIC), or any other digital or analog circuitry configured to interpret and/or execute program instructions and/or process data. Processor 204 may be configured to interpret and/or execute program instructions and/or data stored in memory 206. Program instructions or data may constitute portions of software for carrying out remote distributed sensing as described herein. For example, program instructions may constitute portions of software for using time-domain reflectometry and/or frequency-domain reflectometry to detect the information about the physical parameters of fiber under test 164.

Memory 206 may include any system, device, or apparatus configured to hold and/or house one or more memory modules; for example, memory 206 may include read-only memory, random access memory, solid state memory, or disk-based memory. Each memory module may include any system, device or apparatus configured to retain program instructions and/or data for a period of time (e.g., computer-readable non-transitory media).

Storage unit 208 may provide and/or store any information that suits a particular embodiment. For example, storage unit 208 may provide values that may be used to transmit optical pulses, receive reflections, and analyze reflections to detect information about physical parameters of points along fiber under test 164. Storage unit 208 may provide information used to ensure that optical pulses are transmitted with suitable timing, such as timing the optical pulses to be transmitted close to one another but not so close that reflections from the optical pulses overlap at reflection receiver 212. Information stored in storage unit 208 may also facilitate correlating reflections received with particular times and corresponding physical locations, and analyzing reflections to detect physical parameters and resolve the physical parameters to points along fiber under test 164. Storage unit 208 may also be used to log and/or store information about optical pulses transmitted, reflections received, and/or information derived from analyzing the reflections for later use or further analysis. Storage unit 208 may be implemented in any suitable manner, such as by functions, instructions, logic, or code, and may be stored in, for example, a relational database, file, application programming interface, library, shared library, record, data structure, service, software-as-service, or any other suitable mechanism. Storage unit 208 may include operational code such as functions, instructions, or logic. Storage unit 208 may store and/or specify any suitable parameters that may be used to transmit optical pulses and to receive and analyze reflections from optical pulses.

Interrogation controller 202 may be adapted to direct components of interrogation subsystem 200 to perform various functions. For example, interrogation controller 202 may direct light source 210 to generate an optical pulse. In certain embodiments, interrogation controller 202 may direct light source 210 to generate a series of optical pulses to be transmitted continuously in succession, each optical pulse immediately following receipt of all reflections from a previous optical pulse. Light source 210 may include a coherent laser source for generating an optical pulse, a semiconductor optical amplifier for switching the laser source, a booster amplifier such as an erbium doped fiber amplifier (EDFA) for increasing the maximum power of the optical pulse, one or more active or passive filters for narrowing and/or otherwise conditioning the optical pulse, and any other suitable components.

As shown in FIG. 2, light source 210 may be coupled with power circulator 214. Power circulator 214, in turn, may be coupled with uphole end 156 of transit fiber 154 at bulkhead connector 220. Power circulator 214 may be configured to circulate optical energy in any suitable way. For example, power circulator 214 may operate as a “roundabout” for optical energy. As shown, power circulator 214 may receive optical energy such as an optical pulse from light source 210 and deliver the energy through bulkhead connector 220 into transit fiber 154. Power circulator 214 may also be communicatively coupled to reflection receiver 212. As such, power circulator 214 may receive optical energy such as reflections from the optical pulse transmitted into transit fiber 154, and deliver the reflected energy to reflection receiver 212.

Reflection receiver 212 may be directed (e.g., by interrogation controller 202) to receive and/or perform signal conditioning on reflections from optical pulses. For example, reflection receiver 212 may receive reflections from optical pulses transmitted by light source 210. Reflection receiver 212 may receive Rayleigh backscatter of an optical pulse reflected from various points along transit fiber 154, fiber under test 164, and chromatic dispersion compensator 162. When reflection receiver 212 receives the backscatter reflections, reflection receiver 212 may convey the reflections to interrogation controller 202, which may perform analysis on the backscatter to derive information about physical parameters at the points on the optical fibers where the backscatter reflections originated.

Reflection receiver 212 may be configured to receive reflections automatically or under direction from interrogation controller 202. As such, reflection receiver 212 may receive reflections using any suitable components in any suitable way. For example, reflection receiver 212 may comprise a photodiode configured to convert light from received reflections into an electrical signal. Reflection receiver 212 may perform signal conditioning on the electrical signal and may deliver the electrical signal to interrogation controller 202 for analysis. Reflection receiver 212 may also include one or more components configured to filter reflections received. For example, reflection receiver 212 may filter certain sidebands (e.g., sidebands caused by chromatic dispersion) to decrease noise and narrow in on an information-carrying signal at a central frequency of the reflections. In this way, reflection receiver 212 may attempt to increase a signal-to-noise ratio, which may facilitate the analysis of the reflections by interrogation controller 202.

Modifications, additions, or omissions may be made to interrogation subsystem 200 without departing from the scope of the present disclosure. For example, interrogation subsystem 200 illustrates one particular configuration of components, but any suitable configuration of components may be used. For example, components of interrogation subsystem 200 may be implemented either as physical or logical components. Furthermore, in some embodiments, functionality associated with components of interrogation subsystem 200 may be implemented with special and/or general purpose circuits or components. Components of interrogation subsystem 200 may also be implemented by computer program instructions.

FIG. 3 illustrates a graph of an exemplary optical pulse transmitted by an interrogation subsystem. For example, optical pulse 300 may be generated and transmitted by light source 210 within interrogation subsystem 200, as described in relation to FIG. 2. Optical pulse 300 is shown in the frequency domain, with power shown along the y-axis and wavelength shown along the x-axis. As shown, optical pulse 300 may be characterized by central wavelength 302, spectral width 304, maximum power 306, and half maximum power 308.

Central wavelength 302 of optical pulse 300 may be any suitable wavelength. For example, central wavelength 302 may be in the conventional band (“C-band”) that includes the portion of the electromagnetic spectrum from approximately 1530 nm to approximately 1565 nm, corresponding to the amplification range of certain EDFAs used in optical applications. In some embodiments, central wavelength 302 may be 1550 nm. In other embodiments, central wavelength 302 may be in the visible spectrum from approximately 390 nm to 700 nm, in an infrared spectrum with wavelengths longer than 700 nm, or in an ultraviolet spectrum with wavelengths shorter than 390 nm.

Spectral width 304 of optical pulse 300 may be referred to in terms of frequency or in terms of wavelength using a conversion formula as follows:

c=λ*f

where c represents the universal constant for the speed of light in a vacuum: 299,792,458 m/s, λ represents a wavelength of optical pulse 300, and f represents a frequency of optical pulse 300.

Spectral width 304 may be expressed by its full width at half maximum (FWHM), measured as the difference between upper wavelength 310 and lower wavelength 312, by its half width at half maximum (HWHM), measured as the difference between upper wavelength 310 and central wavelength 302, or by any other suitable methodology. Thus, for example, if central wavelength 302 is 1550 nm, upper wavelength 310 is 1550.4 nm, and lower wavelength 312 is 1549.6 nm, then spectral width 304 may be expressed in FWHM as 0.8 nm (the difference between 1550.4 nm and 1549.6 nm) or as about 100 GHz (the difference between the upper and lower frequencies according to Formula 1).

Optical pulse 300 may be characterized by any suitable spectral width 304. In some examples, spectral width 304 of optical pulse 300 may be narrow to minimize negative effects of classical chromatic dispersion and to thereby expand the reach of the remote distributed sensing. Indeed, in certain embodiments, optical pulse 300 may be substantially monochromatic, or characterized by a near-zero spectral width 304. In a monochromatic optical pulse, all energy of the optical pulse is concentrated at one frequency, making the monochromatic optical pulse immune to classical chromatic dispersion, since classical chromatic dispersion results from different frequencies of light traveling at different phase velocities in the optical fiber. Accordingly, it may be desirable for interrogation subsystem 200 to transmit optical pulse 300 with a near-zero spectral width 304 such that optical pulse 300 will be substantially monochromatic. For example, if light source 210 includes a narrow line width coherent laser source, spectral width 304 of optical pulse 300 may be on the order of approximately 1 kHz. For practical purposes an optical pulse on the order of approximately 1 kHz optical pulse may behave nearly identically to a monochromatic optical pulse with zero spectral width. Specifically, the energy in a 1 kHz optical pulse may be substantially monochromatic at central frequency 302 so as to be immune to classical chromatic dispersion.

In some embodiments, spectral width 304 may be altered before optical pulse 300 is transmitted into transit fiber 154. For example, a semi conductor optical amplifier and a booster amplifier included within light source 210 may condition optical pulse 300 to widen spectral width 304, while one or more passive or active filters included in light source 210 may narrow spectral width 304. Thus, a coherent laser source may generate an optical pulse with a narrow spectral width such as approximately 1 kHz, but spectral width 304 of optical pulse 300 may be considerably wider (e.g., 25 GHz) when optical pulse 300 actually enters transit fiber 154.

Maximum power 306 may relate to the power, intensity, and/or spectral density of light source 210 and the energy contained within optical pulse 300. Maximum power 306 may be associated with a maximum distance that optical pulse 300 can travel in an optical fiber. For example, if maximum power 306 is high, optical pulse 300 may be able to travel a long distance before the energy in optical pulse 300 is reflected back and/or otherwise diminished. Accordingly, for remote distributed sensing of long distances such as many kilometers, it may be advantageous for maximum power 306 of optical pulse 300 to be large. For example, optical pulse 300 may have maximum power 306 equal to approximately 1 Watt. Large maximum power may be applied to optical pulse 300 by using one or more optical amplifiers (e.g., EDFAs) to boost the maximum power of optical pulse 300. However, if maximum power 306 of optical pulse 300 is sufficiently large, optical pulse 300 may induce a nonlinear effect such as a Kerr effect in an optical fiber that optical pulse 300 travels through. Thus, Kerr effect chromatic dispersion may be introduced and noise-inducing sidebands apart from central wavelength 302 may develop on optical pulse 300 even if optical pulse 300 is originally generated with a virtually monochromatic spectral width 304.

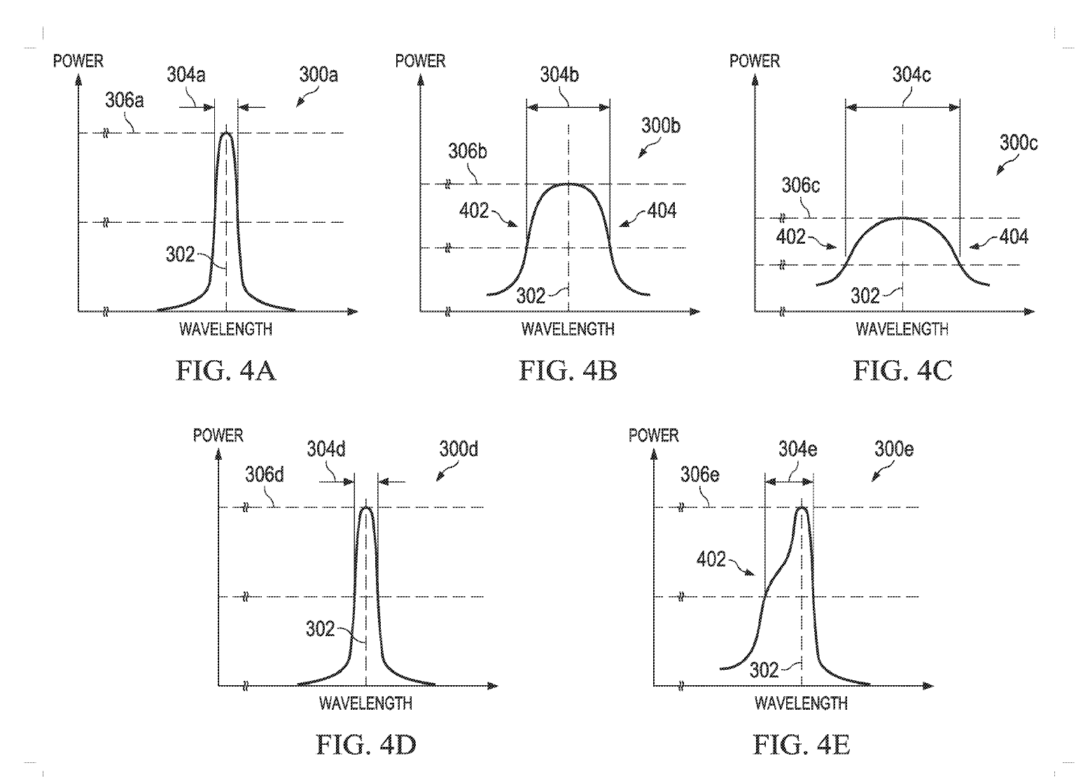

FIGS. 4A through 4E (collectively referred to as FIG. 4) illustrate graphs of an exemplary optical pulse transmitted by an interrogation subsystem as chromatic dispersion is introduced onto the optical pulse and graphs of how the chromatic dispersion is corrected by exemplary chromatic dispersion compensators. The exemplary optical pulse discussed in relation to FIG. 4 is optical pulse 300, described above in reference to FIG. 3. In particular, FIG. 4 illustrates optical pulse 300 at various points along transit fiber 154, chromatic dispersion compensator 162, and fiber under test 164, as described above in reference to FIG. 1. The various stages of optical pulse 300 illustrated in FIG. 4 (e.g., 300a, 300b, etc.) are exemplary only and are not drawn to scale. However, the relative maximum powers 306 (e.g., 306a, 306b, etc.) and optical pulse widths 304 (e.g., 304a, 304b, etc.) shown in FIG. 4 may generally indicate that optical pulse 300 is changing (e.g., the pulse width is increasing and the maximum power is decreasing) as optical pulse 300 travels over the optical fibers in remote distributed sensing system 150.

FIGS. 4A, 4B, and 4C illustrate graphs of optical pulse 300 as optical pulse 300 is conveyed along transit fiber 154 and chromatic dispersion is introduced onto the optical pulse. In the example of FIG. 4, transit fiber 154 may have positive chromatic dispersion at central wavelength 302. As described above, chromatic dispersion may arise from classical chromatic dispersion, from Kerr effect chromatic dispersion, or from a combination of both. FIG. 4A shows exemplary optical pulse 300a, representing optical pulse 300 immediately as it is transmitted into transit fiber 154 from interrogation subsystem 152. As shown, optical pulse 300a may have a relatively narrow FWHM spectral width 304a and a relatively high maximum power 306a. However, as optical pulse 300 travels through transit fiber 154, some energy at central wavelength 302 may disperse into sidebands of optical pulse 300 due to chromatic dispersion.

FIG. 4B shows exemplary optical pulse 300b, representing optical pulse 300 after it has traveled some distance through transit fiber 154. As shown, some energy from central wavelength 302 has dispersed into one or more sidebands 402 with wavelengths shorter than central wavelength 302, and into one or more sidebands 404 with wavelengths longer than central wavelength 302. As shown in FIG. 4B, energy has dispersed from central wavelength 302 by chromatic dispersion, and maximum power 306b has diminished as compared to maximum power 306a while spectral width 304b has increased as compared to spectral width 304a.

As illustrated by optical pulse 300c in FIG. 4C the energy at central wavelength 302 may become even more dispersed after optical pulse 300 travels through transit fiber 154 to arrive at downhole end 158 of transit fiber 154. As shown, sidebands 402 and 404 may include a larger portion of the energy of optical pulse 300c as compared to optical pulse 300b. Similarly, maximum power 306c may be smaller than maximum power 306b, and spectral width 304c may be wider than spectral width 304b. Thus, before remote distributed sensing has even begun in the remote location, optical pulse 300 may have degraded significantly.

FIGS. 4D and 4E illustrate exemplary graphs of optical pulse 300 after chromatic dispersion has been corrected by exemplary chromatic dispersion compensators. Specifically, when optical pulse 300 reaches downhole end 158 of transit fiber 154, a certain amount of positive chromatic dispersion may have been introduced onto optical pulse 300, as illustrated by optical pulse 300c. Thus, chromatic dispersion compensator 162 may introduce an equal amount of negative chromatic dispersion onto optical pulse 300 before optical pulse 300 proceeds into fiber under test 164. Thus, for example, after passing through chromatic dispersion compensator 162 and immediately before entering fiber under test 164, optical pulse 300 may resemble optical pulse 300d, shown in FIG. 4D. Optical pulse 300d may be similar or identical to optical pulse 300a, shown in FIG. 4A. In other words, chromatic dispersion compensator 162 may fully correct the chromatic dispersion introduced by transit fiber 154, thereby virtually providing a direct coupling between interrogation subsystem 152 and fiber under test 164. In other examples, optical pulse 300 may resemble optical pulse 300e, shown in FIG. 4E, after passing through chromatic dispersion compensator 162. In optical pulse 300e, only half of the energy of optical pulse 300 (i.e., the energy formerly in sidebands 404) has been corrected and replaced at central frequency 302 while the other half of the energy (i.e. the energy in sidebands 402) remains dispersed. Although optical pulse 300e may not represent a direct virtual coupling of interrogation subsystem 152 and fiber under test 164, optical pulse 300e may still provide an improved signal-to-noise ratio as compared to optical pulse 300c because optical pulse 300e has more optical energy at central wavelength 302 where interrogation subsystem 152 is configured to receive reflections, and less optical energy at long wavelength sidebands, where interrogation subsystem 152 receives noise. Accordingly, by correcting chromatic dispersion in optical pulse 300c to generate optical pulse 300d or 300e, chromatic dispersion compensator 162 may improve remote distributed sensing system 150.

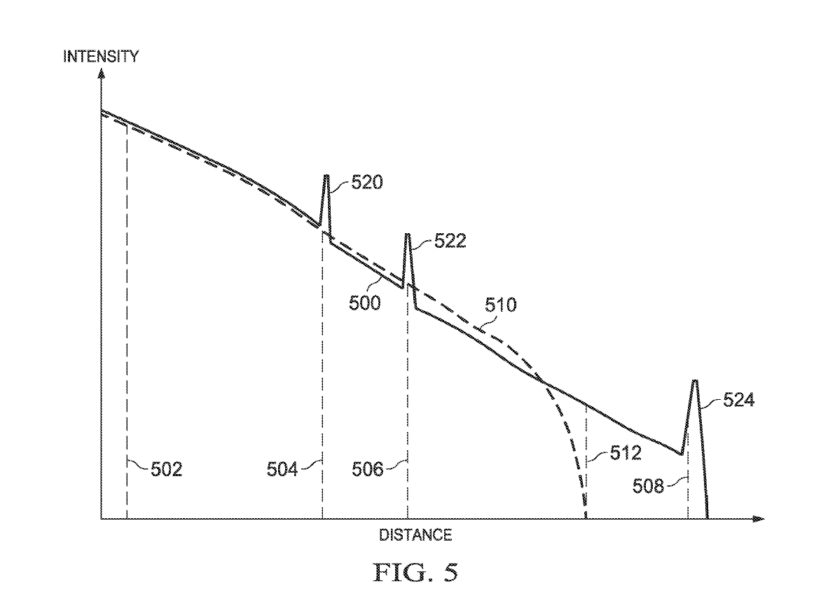

FIG. 5 illustrates a Rayleigh backscatter plot of exemplary reflections received by an interrogation subsystem. Specifically, Rayleigh backscatter plot 500 illustrates the amplitude or intensity of reflections (e.g., Rayleigh backscatter) received by an interrogation subsystem as a function of the distance from the interrogation subsystem at which the reflections originated. For example, backscatter plot 500 shows that the maximum backscatter intensity is for backscatter originating at the interrogation subsystem. Intensity of backscatter then generally decreases as the reflections originate at greater distances from the interrogation subsystem, giving backscatter plot 500 a generally negative slope. Accordingly, backscatter originating at distance 502 along transit fiber 154 has a lower intensity than the backscatter that originated closer to the interrogation subsystem. At distance 504 and distance 506, reflective faults in remote distributed sensing system 150 are indicated by spikes 520 and 522, respectively. Reflective faults may arise at a junction of two optical fibers, at a junction of an optical fiber and a chromatic dispersion compensator, or at other irregular points within a remote distributed sensing system. For example, spike 520 at distance 504 may indicate a reflective fault at the junction of downhole end 158 of transit fiber 154 and chromatic dispersion compensator 162 (as shown in FIG. 1). Similarly, spike 522 at distance 506 may indicate a reflective fault at the junction of chromatic dispersion compensator 162 and uphole end 166 of fiber under test 164. Although not shown in backscatter plot 500, other spikes of various magnitudes indicative of other reflective faults may be observed on a Rayleigh backscatter plot. For example, other spikes may indicate reflective faults such as joints, bends, strains, regions with higher or lower temperatures or pressures, and/or any other irregularities that may result in more backscatter at one point of an optical fiber than another. Finally, as shown at distance 508, the remaining energy of optical pulse 300 may be reflected in final high intensity spike 524 at reflection end 168 of fiber under test 164, which is the downhole-most point of remote distributed sensing system 150.

Illustrated with backscatter plot 500, exemplary backscatter plot 510 may represent the amplitude or intensity of reflections (e.g., Rayleigh backscatter) received by an interrogation subsystem of a different remote distributed sensing system as a function of distance from the interrogation subsystem at which the reflections originated. The remote distributed sensing system associated with backscatter plot 510 is different from remote distributed sensing system 150 in that the remote distributed sensing system associated with backscatter plot 510 does not employ a chromatic dispersion compensator. So that backscatter plot 510 may be clearly illustrated, backscatter plot 510 may be drawn slightly below backscatter plot 500 in FIG. 5 so that backscatter plots 500 and 510 do not overlap. However, it will be understood that certain portions of backscatter plots 500 and 510 may overlap in regions where the received backscatter is similar or identical (e.g., prior to where the effects of chromatic dispersion compensator 162 begin on backscatter plot 500 at distance 504).

One notable difference between backscatter plot 500 and backscatter plot 510 is that backscatter plot 510 shows no spikes indicative of reflective faults at distances 504 and 508. Because the remote distributed sensing system associated with backscatter plot 510 lacks a chromatic dispersion compensator, the transit fiber and the fiber under test of that remote distributed sensing system may be a unitary, continuous optical fiber with no reflective faults. Accordingly, backscatter plot 510 has a slightly higher intensity at distance 506 because less energy from the optical pulse has been reflected back than in remote distributed sensing system 150 associated with backscatter plot 500. However, at distance 512, backscatter plot 510 completely collapses before the optical pulse has reached the reflection end of the fiber under test at distance 508. Collapse of a backscatter signal may occur when chromatic dispersion decreases the signal-to-noise ratio of the backscatter signal so severely that information can no longer be resolved from the reflections. In other words, the noise generated by sidebands of the optical pulse represented by backscatter plot 510 becomes so significant by distance 512 that the noise completely overpowers the signal at the central wavelength of the optical pulse. Thus, remote distributed sensing using the remote distributed sensing system of backscatter plot 510 is limited to total a distance less than distance 512.

Meanwhile, remote distributed sensing system 150, represented by backscatter plot 500, can extend beyond distance 512 without the collapse of backscatter plot 500. Because remote distributed sensing system 150 includes chromatic dispersion compensator 162 coupled in-line between transit fiber 154 and fiber under test 164, remote distributed sensing system 150 may perform remote distributed sensing at distances greater than distance 512. For example, as shown by backscatter plot 500, chromatic dispersion compensator 162 may allow remote distributed sensing system 150 to resolve information about physical parameters as far away from the interrogation subsystem as at least distance 508.

Embodiments disclosed herein include:

A. A remote distributed sensing system including an interrogation subsystem configured to transmit an optical pulse and receive a reflection from the optical pulse, a transit optical fiber with a first end coupled to the interrogation subsystem, the transit optical fiber having chromatic dispersion of a first slope at a frequency of the optical pulse, an optical fiber under test with a first end coupled to a second end of the transit optical fiber, the optical fiber under test being located in a remote location apart from the interrogation subsystem, and a chromatic dispersion compensator of a second slope coupled in-line with at least one of the transit optical fiber and the optical fiber under test, the chromatic dispersion compensator configured to adjust chromatic dispersion on the optical pulse in a direction of the second slope as the optical pulse travels from the interrogation subsystem toward a second end of the optical fiber under test, the second slope having an opposite sign from the first slope.

B. A method for performing remote distributed sensing with improved signal-to-noise, the method including transmitting an optical pulse from an interrogation subsystem, conveying the optical pulse via a transit optical fiber having chromatic dispersion of a first slope at a frequency of the optical pulse, a first end of the transit optical fiber coupled to the interrogation subsystem, conveying the optical pulse via an optical fiber under test being located in a remote location apart from the interrogation subsystem, a first end of the optical fiber under test coupled to a second end of the transit optical fiber, adjusting chromatic dispersion on the optical pulse in a direction of a second slope via a chromatic dispersion compensator of the second slope coupled in-line with at least one of the transit optical fiber and the optical fiber under test as the optical pulse travels from the interrogation subsystem toward a second end of the optical fiber under test, the second slope having an opposite sign from the first slope, and receiving a reflection from the adjusted optical pulse at the interrogation subsystem.

C. A method for retrofitting a distributed sensing system to improve signal to noise, the method including selecting an existing distributed sensing system, the existing distributed sensing system comprising a transit optical fiber configured to convey an optical pulse and having chromatic dispersion of a first slope at a frequency of the optical pulse, and an optical fiber under test configured to convey the optical pulse and coupled to the transit optical fiber, and coupling, in-line to at least one of the transit optical fiber and the optical fiber under test, a chromatic dispersion compensator of a second slope configured to adjust chromatic dispersion on the optical pulse in a direction of the second slope as the optical pulse travels through the transit optical fiber and the optical fiber under test, the second slope having an opposite sign from the first slope.

Each of embodiments A, B, and C may have one or more of the following additional elements in any combination: Element 1: wherein the chromatic dispersion compensator comprises at least one of an optical fiber having chromatic dispersion of the second slope at the frequency of the optical pulse and a fiber Bragg grating configured to introduce chromatic dispersion in the direction of the second slope onto the optical pulse. Element 2: wherein the first slope is positive and the second slope is negative. Element 3: wherein the chromatic dispersion compensator is coupled in-line between the second end of the transit optical fiber and the first end of the optical fiber under test. Element 4: wherein the interrogation subsystem comprises a coherent laser source having a power level sufficient to induce a nonlinear effect in at least one of the transit optical fiber and the optical fiber under test, the optical pulse is transmitted by the coherent laser source at the power level, and the chromatic dispersion includes Kerr effect chromatic dispersion associated with the power level of the optical pulse. Element 5: wherein the interrogation subsystem is further configured to analyze the reflection to detect distributed information about the remote location. Element 6: wherein the distributed information about the remote location is selected from a group consisting of acoustic pressure, particle vibration, particle displacement, particle velocity, particle acceleration, temperature, strain, pressure, and any combination thereof. Element 7: wherein the reflection from the optical pulse comprises Rayleigh backscatter. Element 8: wherein the chromatic dispersion compensator is coupled in-line with the at least one of the transit optical fiber and the optical fiber under test as a retrofit after the transit optical fiber has been coupled to the interrogation subsystem and coupled to the first end of the optical fiber under test and after the optical fiber under test has been positioned in the remote location.

Although the present disclosure and its advantages have been described in detail, it should be understood that various changes, substitutions and alterations can be made herein without departing from the spirit and scope of the disclosure as defined by the following claims.

What is claimed is:

1. A remote distributed sensing system, comprising:
an interrogation subsystem configured to transmit an optical pulse and receive a reflection from the optical pulse;
a transit optical fiber with a first end coupled to the interrogation subsystem, the transit optical fiber having chromatic dispersion of a first slope at a frequency of the optical pulse;
an optical fiber under test with a first end coupled to a second end of the transit optical fiber, the optical fiber under test being located in a remote location apart from the interrogation subsystem; and
a chromatic dispersion compensator of a second slope coupled in-line with at least one of the transit optical fiber and the optical fiber under test, the chromatic dispersion compensator configured to adjust chromatic dispersion on the optical pulse in a direction of the second slope as the optical pulse travels from the interrogation subsystem toward a second end of the optical fiber under test, the second slope having an opposite sign from the first slope.

2. The remote distributed sensing system of claim 1, wherein the chromatic dispersion compensator comprises at least one of an optical fiber having chromatic dispersion of the second slope at the frequency of the optical pulse and a fiber Bragg grating configured to introduce chromatic dispersion in the direction of the second slope onto the optical pulse.

3. The remote distributed sensing system of claim 2, wherein the first slope is positive and the second slope is negative.

4. The remote distributed sensing system of claim 1, wherein the chromatic dispersion compensator is coupled in-line between the second end of the transit optical fiber and the first end of the optical fiber under test.

5. The remote distributed sensing system of claim 1, wherein:
the interrogation subsystem comprises a coherent laser source having a power level sufficient to induce a nonlinear effect in at least one of the transit optical fiber and the optical fiber under test;
the optical pulse is transmitted by the coherent laser source at the power level; and
the chromatic dispersion includes Kerr effect chromatic dispersion associated with the power level of the optical pulse.

6. The remote distributed sensing system of claim 1, wherein the interrogation subsystem is further configured to analyze the reflection to detect distributed information about the remote location.

7. The remote distributed sensing system of claim 6, wherein the distributed information about the remote location is selected from a group consisting of acoustic pressure, particle vibration, particle displacement, particle velocity, particle acceleration, temperature, strain, pressure, and any combination thereof.

8. The remote distributed sensing system of claim 1, wherein the reflection from the optical pulse comprises Rayleigh backscatter.

9. The remote distributed sensing system of claim 1, wherein the chromatic dispersion compensator is coupled in-line with the at least one of the transit optical fiber and the optical fiber under test as a retrofit after the transit optical fiber has been coupled to the interrogation subsystem and coupled to the first end of the optical fiber under test and after the optical fiber under test has been positioned in the remote location.

10. A method for performing remote distributed sensing with improved signal-to-noise, the method comprising:
transmitting an optical pulse from an interrogation subsystem;
conveying the optical pulse via a transit optical fiber having chromatic dispersion of a first slope at a frequency of the optical pulse, a first end of the transit optical fiber coupled to the interrogation subsystem;
conveying the optical pulse via an optical fiber under test being located in a remote location apart from the interrogation subsystem, a first end of the optical fiber under test coupled to a second end of the transit optical fiber;
adjusting chromatic dispersion on the optical pulse in a direction of a second slope via a chromatic dispersion compensator of the second slope coupled in-line with at least one of the transit optical fiber and the optical fiber under test as the optical pulse travels from the interrogation subsystem toward a second end of the optical fiber under test, the second slope having an opposite sign from the first slope; and
receiving a reflection from the adjusted optical pulse at the interrogation subsystem.

11. The method of claim 10, wherein the chromatic dispersion compensator comprises at least one of an optical fiber having chromatic dispersion of the second slope at the frequency of the optical pulse and a fiber Bragg grating configured to introduce chromatic dispersion in the direction of the second slope onto the optical pulse.

12. The method of claim 11, wherein the first slope is positive and the second slope is negative.

13. The method of claim 10, wherein the chromatic dispersion compensator is coupled in-line between the second end of the transit optical fiber and the first end of the optical fiber under test.

14. The method of claim 10, wherein:
the interrogation subsystem comprises a coherent laser source having a power level sufficient to induce a nonlinear effect in at least one of the transit optical fiber and the optical fiber under test;
the optical pulse is transmitted by the coherent laser source at the power level; and
the chromatic dispersion includes Kerr effect chromatic dispersion associated with the power level of the optical pulse.

15. The method of claim 10, further comprising analyzing, by the interrogation subsystem in response to receiving the reflection, the reflection to detect distributed information about the remote location.

16. The method of claim 15, wherein the distributed information about the remote location is selected from a group consisting of acoustic pressure, particle vibration, particle displacement, particle velocity, particle acceleration, temperature, strain, pressure, and any combination thereof.

17. The method of claim 10, wherein the reflection from the optical pulse comprises Rayleigh backscatter.

18. The method of claim 10, wherein the chromatic dispersion compensator is coupled in-line with the at least one of the transit optical fiber and the optical fiber under test as a retrofit after the transit optical fiber has been coupled to the interrogation subsystem and coupled to the first end of the optical fiber under test and after the optical fiber under test has been positioned in the remote location.

19. A method for retrofitting a distributed sensing system to improve signal to noise, the method comprising:
selecting an existing distributed sensing system, the existing distributed sensing system comprising a transit optical fiber configured to convey an optical pulse and having chromatic dispersion of a first slope at a frequency of the optical pulse, and an optical fiber under test configured to convey the optical pulse and coupled to the transit optical fiber; and
coupling, in-line to at least one of the transit optical fiber and the optical fiber under test, a chromatic dispersion compensator of a second slope configured to adjust chromatic dispersion on the optical pulse in a direction of the second slope as the optical pulse travels through the transit optical fiber and the optical fiber under test, the second slope having an opposite sign from the first slope.

20. The method of claim 19, wherein the chromatic dispersion compensator comprises at least one of an optical fiber having chromatic dispersion of the second slope at the frequency of the optical pulse and a fiber Bragg grating configured to introduce chromatic dispersion in the direction of the second slope onto the optical pulse.
